(19) United States
(12) Patent Application Publication
(10) Pub. No.: US 2026/0229018 A1
(43) Pub. Date: Aug. 6, 2026

(54) SYSTEMS AND METHODS FOR USING MULTIMODAL LLMS TO IDENTIFY NON-COMPLIANT USER INTERFACES

(71) Applicant: Shopify Inc., Ottawa (CA)

(72) Inventors: Brandon REID, Dartmouth (CA); James VARGA, Toronto (CA); Samuel Joseph OSBORNE, JR., Bloomington, IN (US)

(73) Assignee: Shopify Inc., Ottawa, ON (CA)

(21) Appl. No.: 19/042,065

(22) Filed: Jan. 31, 2025

(51) Int. Cl. G06V 10/766; G06F 9/451; G06F 40/117

(52) U.S. Cl. CPC G06V 10/766; G06F 9/451; G06F 40/117

(57) ABSTRACT

Methods and systems for identifying non-compliance of a user interface with a guideline are described. The methods and systems may include: detecting a trigger condition; prompting a large language model to identify an element of a user interface non-compliant with a guideline, wherein prompting includes providing an image showing at least a portion of the user interface to the large language model; receiving a first output of the large language model; identifying, based on the first output, the element that is non-compliant with the guideline; and presenting, on a display, an indication that the element is non-compliant. The guideline may include a semantic criterion paring a textual context with a visual condition.

### FIELD

The present disclosure relates to multimodal large language models (LLMs), and, more particularly, to using multimodal LLMs to compare user interfaces (UIs) against a set of guidelines and identifying non-compliance.

### BACKGROUND

Many enterprises use applications (apps) and websites in their business operations. In some instances, these apps and websites may be subject to a set of guidelines. For example, a corporation or platform may require all apps associated with the corporation to have a UI that has a certain “look.” Additionally or alternatively, having an app with a UI that is compliant with a set of guidelines may qualify the app for a status or qualification with respect to a platform. An example of such a status or qualification is the Built for Shopify status given by Shopify to apps. In these instances, it is desirable for app or web developers to develop apps or webpages adhering to specific design guidelines established by platforms to ensure consistency, usability, and accessibility. However, these guidelines may be difficult to verify or enforce through traditional static analysis methods. For example, some content and styling rules are only applicable or visible once a web page is fully rendered and interacted with by a user. In some cases, the platform may mandate use of specific background colors for banners based on the semantic context of the content within the banners: a blue background for informational banners, a red background for warning banners about destructive actions or critical errors or a green banner for notifications on successful executions. Moreover, semantic guidelines can require nuanced content evaluation, such as avoiding jargon, overly technical language, or idioms, which requires a deeper semantic understanding of the content. Another relevant guideline could be the use of intuitive icons in navigation bars that visually complement the text of the menu item and avoid ambiguity or confusion with other icons within the same menu bar. Static HTML/CSS analysis tools cannot address these requirements as they lack the capability to perceive shape or interpret the semantic correctness of language and iconography within the UI. This leaves developers without adequate tools to identify and address non-compliance effectively in the design and content of UIs before they are deployed via an app or website. Further, while it is possible to, at least partially, enforce UI guidelines by requiring developers to use a specific technology or UI framework, the developers may be unfamiliar with the specific technology or UI framework. Thus, there is need for a tool that can detect non-compliance with guidelines based on semantic correctness. Further, it is desirable if this tool is independent of any particular UI framework or the like.

### BRIEF DESCRIPTION OF THE DRAWINGS

Embodiments will be described, by way of example only, with reference to the accompanying figures wherein:

FIG. 1 is a simplified diagram of an example convolutional neural network (CNN), which is an example of a deep neural network (DNN) that is commonly used for image processing tasks such as image classification, image analysis, object segmentation, etc.

FIG. 2 is a simplified diagram of an example transformer which is a type of neural network architecture.

FIG. 3 is a simplified diagram of an example computing environment for using a multimodal LLM to detect non-compliance of a UI with a set of guidelines.

FIG. 4 is a simplified block diagram of an example computer system used for detecting non-compliance of a UI with a set of guidelines.

FIG. 5 shows, in flowchart form, a method for detecting non-compliance of a UI with a set of guidelines.

FIG. 6 is a simplified diagram of a user interface of an example integrated development environment (IDE) used for detecting non-compliance of a UI with a set of guidelines.

### DETAILED DESCRIPTION

In an aspect, the present application discloses a computer-implemented method. The computer-implemented method comprises: detecting a trigger condition; prompting a large language model to identify an element of a user interface non-compliant with a guideline, wherein prompting includes providing an image showing at least a portion of the user interface to the large language model; receiving a first output of the large language model; identifying, based on the first output, the element that is non-compliant with the guideline; and presenting, on a display, an indication that the element is non-compliant.

In some implementations, the guideline includes a semantic criterion pairing a textual context with a visual condition.

In some implementations, the method further comprises: in response to identifying the element, providing, to the large language model, data defining the user interface, and prompting the large language model to identify a data segment of the data, the data segment causing non-compliance of the user interface with the guideline. The method further comprises: receiving a second output of the large language model; identifying, based on the second output, the data segment; and presenting, on the display, an indication based on the data segment.

In some implementations, the method further comprises fine-tuning the large language model to detect non-compliance of the user interface with the guideline.

In some implementations, detecting the trigger condition further comprises: performing an image regression analysis; and determining, based on the image regression analysis, that the user interface has visually changed by a degree beyond a threshold.

In some implementations, detecting the trigger condition further comprises detecting that a change to data defining the user interface has been stored in a permanent storage medium.

In some implementations, detecting the trigger condition further comprises: tracking changes to data defining the user interface; and determining based on the tracked changes that the data defining the user interface has been changed by a degree beyond a threshold.

In some implementations, detecting the trigger condition further comprises detecting that at least a first element of the user interface with a known compliance guideline has been changed.

In some implementations, presenting the indication on the display further comprises: rendering, subsequent to identifying the element, a markup image of the user interface; and overlaying highlights on the markup image of the user interface, the highlights indicating the element.

In some implementations, presenting the indication on the display further comprises: extracting, subsequent to identifying the element, based on bounding box data, a markup image depicting the element; and presenting the markup image on the display.

In some implementations, the method further comprises, prior to prompting the large language model to identify at least one element of the user interface non-compliant with the guideline, capturing the image showing at least the portion of the user interface.

In some implementations, the large language model is a first large language model of a plurality of large language models. The method further comprises, prior to prompting the large language model to identify the element: determining that the first large language model evaluates compliance of the user interface with the guideline; and selecting the first large language model from the plurality of large language models.

In another aspect, the present application discloses a computer system. The computer system comprises at least one processor and at least one memory coupled to the at least one processor. The at least one memory stores instructions that, when executed by the processor, cause the at least one processor to: detect a trigger condition; prompt a large language model to identify an element of a user interface non-compliant with a guideline, wherein prompting includes providing an image showing at least a portion of the user interface to the large language model; receive a first output of the large language model; identify, based on the first output, the element that is non-compliant with the guideline; and present, on a display, an indication that the element is non-compliant.

In some implementations, the guideline includes a semantic criterion pairing a textual context with a visual condition.

In some implementations, the instructions further configure the at least one processor to in response to identifying the element, provide, to the large language model, data defining the user interface, and prompt the large language model to identify a data segment of the data, the data segment causing non-compliance of the user interface with the guideline. The instructions further configure the at least one processor to: receive a second output of the large language model; identify, based on the second output, the data segment; and present, on the display, an indication based on the data segment.

In some implementations, the instructions further configure the at least one processor to fine-tune the large language model to detect non-compliance of the user interface with the guideline.

In some implementations, presenting the indication on the display further comprises: rendering, subsequent to identifying the element, a markup image of the user interface; and overlaying highlights on the markup image of the user interface, the highlights indicating the element.

In some implementations, presenting the indication on the display further comprises: extracting, subsequent to identifying the element, based on bounding box data, a markup image depicting the element; and presenting the markup image on the display.

In some implementations, the large language model is a first large language model of a plurality of large language models. The instructions further configure the at least one processor to, prior to prompting the large language model to identify the element: determine that the first large language model evaluates compliance of the user interface with the guideline; and select the first large language model from the plurality of large language models.

In another aspect, the present application discloses a non-transitory computer-readable medium. The non-transitory computer-readable medium stores instructions that, when executed by at least one processor, causes the at least one processor to: detect a trigger condition; prompt a large language model to identify an element of a user interface non-compliant with a guideline, wherein prompting includes providing an image showing at least a portion of the user interface to the large language model; receive a first output of the large language model; identify, based on the first output, the element that is non-compliant with the guideline; and present, on a display, an indication that the element is non-compliant.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

The term “real-time”, “near real-time”, or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 millisecond, less than 1 second, or less than 5 seconds.

In the present application, reference may be made to the term “policy”. A policy may generally refer to a data structure and/or information. A policy may include a set of preferences, rules, conditions or other criteria for defining the behaviour of operations of the e-commerce platform or a component or function thereof. The policy may be used to provide store-specific and/or server-specific policy data that is customizable on a per-store and/or per-server basis. The policy may include a merchant defined policy or a subscription plan (e.g. a fee structure indicating the level of service provided by an e-commerce platform to an online store). In some embodiments, the policy may be configured, for example, by a merchant via a user interface provided by an e-commerce platform.

In the present application, reference may be made to the term “computing resource”. A computing resource may refer to a physical and/or intangible computer component that is used to service a request received by a system. Examples of a resource include a file, file handle, database, network connection, network socket, port (physical and virtual), processor (both time on a processor and use of multiple processors), thread (e.g. database threads), storage medium, computer memory, software module or application, webpage, checkout function, order function, payment function, shipping rate function, tax rate function, credit card validation function, address validation function, postal or zip code validation function, order form validation function, order tracking function, order return function, currency conversion function, new customer registration function, and/or a chat function connecting a user of the user device with a customer service representative of an online store. In some cases, a resource includes a device or a server, such as a cloud server, file server, print server, database server, web server, and the like. A resource may also be provided as a service, including a cloud computing service, a software as a service (SaaS), and the like. In some cases, a resource may include a stand-alone component or service, such as, for example, a component or service external to an e-commerce platform.

### Neural Networks and Machine Learning

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g., each data entry in the training dataset may be paired with a label), or may be unlabeled.

Training a ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value output by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

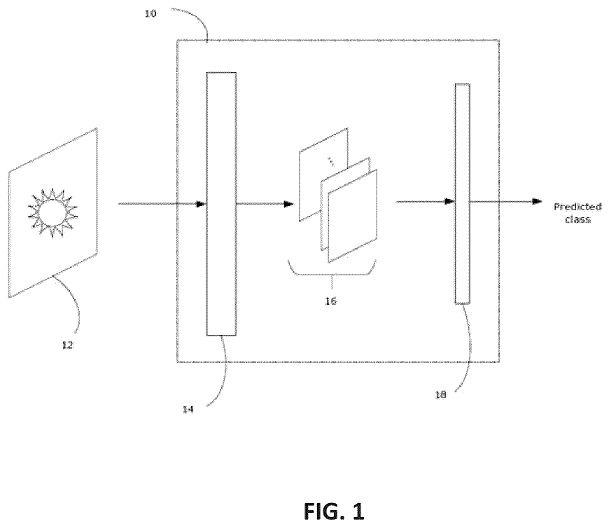

FIG. 1 is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

A multimodal LLM is a type of LLM that can process multiple modalities. For example, the input and output of a multimodal LLM may have different modalities. For example, a multimodal LLM may take an image as input and output text or vice versa. In a specific example, a multimodal LLM may take in an image of a street sign and output text corresponding to the text of the street sign. Additionally, or alternatively, a multimodal LLM may take inputs from different modalities. For example, a multimodal LLM may take an image and text as input. In a specific example, a multimodal LLM may receive inputs corresponding to an image of a portrait of a historical individual (e.g. George Washington) and a textual prompt such as “Identify this person” or “Who is this?” Additionally, or alternatively, a multimodal LLM may have outputs from different modalities. For example, a multimodal LLM may output an image and text. In a specific example, a multimodal LLM may, in response to a prompt such as “Show me a famous painting,” output an image of famous painting (e.g. The Scream by Edvard Munch) and the title of the famous painting in text (e.g. “The Scream”).

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

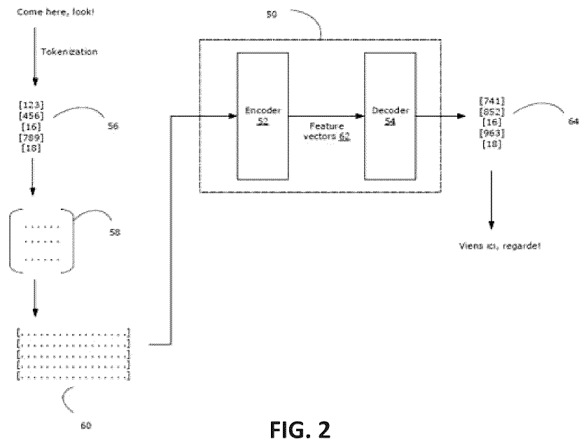

FIG. 2 is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language and it may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 2, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally, or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally, or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

The present disclosure will now proceed to discuss applying multimodal LLMs to detect non-compliance of a UI with a least one guideline.

### Using Multimodal LLMs to Detect Non-Compliance of a UI With at Least One Guideline

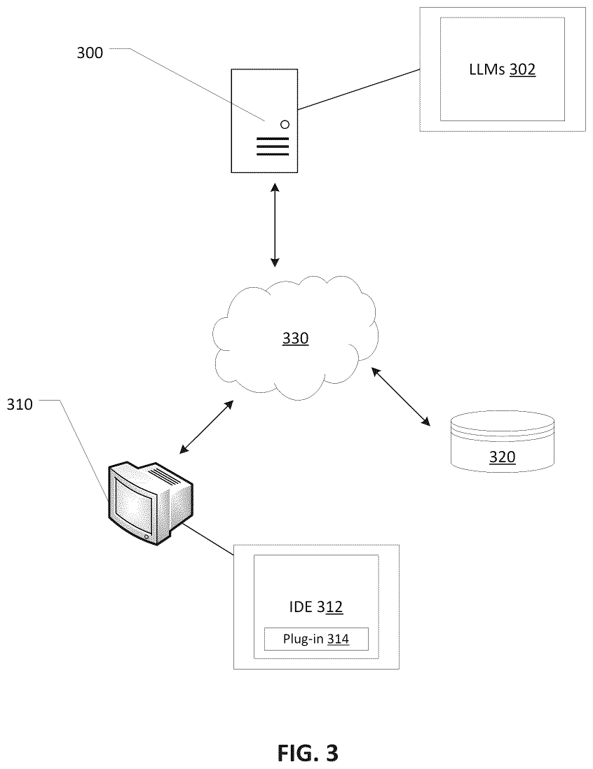

FIG. 3 is a simplified diagram of an example computing environment for using a multimodal LLM to detect non-compliance of a UI with a set of guidelines. FIG. 3 shows a computer system 300, a computing device 310, a database 320, and a network 330 connecting the computer system 300, the computing device 310, and the database 320.

The computer system 300 (depicted as a server) may be a computer system associated with managing and training of the multimodal LLMs used to detect non-compliance of UIs. The computer system 300 may access, train, use, or modify the at least one LLM 302. The at least one LLM 302 may include at least one multimodal LLM. In some embodiments, the at least one LLM 302 may be stored in and accessed from an internal storage of the computer system 300. In other embodiments, the at least one LLM 302 may be stored in and accessed from an external or remote storage medium, such as a cloud server.

In some embodiments, the at least one LLM 302 may take, as input, a screenshot or image of a rendered UI of an app or webpage. The at least one LLM 302 may then generate output denoting specific sections of the rendered UI that are non-compliant with a set of guidelines. The generated output may include attribute data associated with the non-compliant sections of the UI. The attribute data may include, without limitation, text content, color, element type (e.g. banner, icon, navigation bar, etc.), and context (warning, information, success). The attribute data may be formatted in a structure format such as a JSON blob. The output of the at least one LLM 302 may also denote the specific guideline that has been violated or breached. In some embodiments, the generated output may include a markup version of the screenshot or image of the rendered UI. That markup may identify or highlight non-compliant sections of the rendered UI. In some embodiments, the LLM 302 may cause overlay highlights to appear over the rendered UI, in the non-compliant sections, in for example, an app developing environment such as an IDE. For example, the IDE may contain software that receives the output of the LLM and generates a markup image of the UI (similar to the one described above). In some embodiments, the generated output may include images of non-compliant sections of the rendered UI that have been extracted based on bounding box data. The extracted images may be presented on a display used by the developer of the UI.

The at least one LLM 302 may be trained or fine-tuned to detect non-compliance or evaluate compliance of a UI element based on at least one guideline that includes, incorporates, or considers semantic context or criteria. A semantic context or criterion may pair at least one textual context with at least one visual condition. For example, a guideline may mandate the use of specific background colors for banners depending on the semantic context. In a specific example, a guideline may mandate that informational banners have a blue background, warning banners have a red background, and success notification banners have a green background. In a first example scenario, using the same example guideline, providing an image of a rendered UI of an app to at least one LLM 302 may cause the at least one LLM 302 to identify that a blue background for a banner reading “Selecting submit is non-retractable” is non-compliant. Specifically, the at least one LLM 302 may identify that 1) “Selecting submit is non-retractable” is a warning or has the context of a warning, and 2) the blue background color of the banner does not match the warning context which should have a red background color. In a second example scenario, using the same example guideline, the at least one LLM 302 may identify that a green background for a banner reading “Transaction complete” is compliant with the example guideline. Specifically, the at least one LLM 302 may identify that 1) “Transaction complete” is a success notification or has a success notification context, and 2) the green background color matches the context of a success notification. While the specific example of banners is used to describe using the at least one LLM 302 to detect non-compliance of a UI element based on semantic context, the banner example is a non-limiting example. Other examples of semantic context-based guidelines include, without limitation, icons, pop-ups, chat boxes, navigation bars, emojis, GIFs, links, tables, diagrams, graphs, and login portals.

In some embodiments, the computer system 300 may train the at least one LLM 302 by fine-tuning the at least one LLM 302. Example training data used to fine-tune the at least one LLM 302 may include a rendered image of an example UI and a matching markup image that marks up non-compliant sections of the rendered image relative to a set of guidelines.

In some embodiments, the at least one LLM 302 may include different multimodal LLMs that have been fine-tuned or trained to identify or detect non-compliance of UI elements with a specific guideline or a specific group of guidelines. For example, a first one of the at least one LLM 302 may be fine-tuned to detect compliance and non-compliance with respect to banners, a second one of the at least one LLM 302 may be fine-tuned to detect compliance and non-compliance with respect to icon usage, a third one of the at least one LLM 302 may be fine-tuned to detect compliance and non-compliance with respect to navigation bars, and a fourth one of the at least one LLM 302 may be fine-tuned to identify sections or segments of computer code or computer script defining the UI (such as Javascript or HTML of the document object model (DOM)) that cause non-compliance of an identified element of the UI. In some embodiments, the computer system 300 may select a LLM from the at least one LLM 302 to use for detecting compliance and non-compliance with a guideline. For example, the computer system 300 may detect that a UI that has been saved has only changed, or substantially changed, banners compared to the previous save. In this example scenario, the computer system 300 may use a LLM that has been fine-tuned to detect compliance and non-compliance of banners in a UI for the purpose of detecting compliance and non-compliance with a set of guidelines. Further, the computer system 300 may not use a LLM that has been fine-tuned to detect compliance and non-compliance of a navigation bar (assuming that the navigation bar has not changed, or substantially changed, in this example scenario).

In some embodiments, the computer system 300 may make multiple calls to the at least one LLM 302. For example, in response to a first call to a first one of the at least one LLM 302, the first one may generate output identifying non-compliant sections of a rendered UI. A successive second call may be made to the at least one LLM 302. The successive second call may input at least a portion of the computer code or computer script defining the UI, such as Javascript or HTML, and prompt the at least one LLM 302 to identify segments in the computer code or computer script, such as a segment of Javascript or a node in the DOM, that correspond to the non-compliant sections of the UI. In response to the second call, the at least one LLM 302, may overlay highlighting over the segments of computer code or computer script corresponding to the non-compliant sections. In some implementations, the second call may be made to the same LLM that was used for the first call (i.e. the first one of the at least one LLM 302). In other implementations, the second call may be made to a second LLM different from the LLM used for the first call (i.e. a second one of the at least one LLM 302). In another embodiment involving successive calls to the at least one LLM 302, the computer system 300 may make 1) a first call to a first one of the at least one LLM 302 to identify, for example, non-compliance with respect to banners, and 2) a second, successive or simultaneous, call to a second one of the at least one LLM 302 to identify, for example, non-compliance with respect to icon usage.

In another implementation, an image size of a UI may cause the computer system 300 to make multiple calls to the at least one LLM 302. For example, the at least one LLM 302 may have limitations regarding the sizes of images that can be processed. That is, the at least one LLM 302 may not be able to process or effectively process image sizes exceeding a threshold. The computer system 300 may detect or determine that an image of a rendered UI has an image size exceeding this threshold. In response thereto, the computer system 300 may split the image of the rendered UI into a plurality of chunks wherein 1) each chunk does not exceed the threshold and 2) combining the chunks recreates the image of the rendered UI. The computer system 300 may then, for each chunk, make a call to the at least one LLM 302 for compliance evaluation. The computer system 300 may further combine or otherwise process the outputs of the at least one LLM 302 based on each of the calls to provide a single evaluation or output for the entire image of the rendered UI.

The computing device 310 (depicted as a desktop computer) may be a computer used by a developer such as an app developer or a web developer. The developer may be developing a UI according to a set of guidelines. The computing device 310 may have installed thereon an integrated development environment (IDE) 312. The IDE 312 may allow the developer to develop the UI according to the set of guidelines. The computer device 310 may further have installed thereon a plug-in 314 for the IDE 312.

The plug-in 314 may allow the computing device 310 to use the at least one LLM 302 for the purpose of identifying non-compliant sections of a UI being developed using the IDE. In some embodiments, the plug-in may allow the computing device to interact with the computer system 300 via an API. For example, the computing device 310, may send, to the computer system 300, data relating to a UI along with a request to identify non-compliant sections in the UI. The computer system 300 may then make a call to the at least one LLM 302 to identify the non-compliant sections, if any, and send the results or output of the at least one LLM 302 to the computing device 310. In another example, the computing device 310 may send, to the computer system 300, a request for access to the at least one LLM 302. In response to receiving the request, the computer system 300 may send, to the computing device 310, a key, link, or address that allows the computing device 310 to directly make calls to the at least one LLM 302 via the IDE 312.

In some embodiments, prior to prompting the at least one LLM 302 to evaluate a UI for compliance, the plug-in 314 may cause the computing device 310 to render and capture at least one image of the UI (for example via a screen shot) or an image of a portion of the UI. The computing device 310 or the computer system 300 may then prompt the at least one LLM 302 to evaluate the UI for compliance using the captured image(s).

In some embodiments, rendering and capturing the at least one image of the UI may involve concatenating different views of the UI. For example, in the case of a long webpage or application UI that cannot be completely viewed within a display, such as a monitor of a computer or screen of a smartphone, the plug-in 314 may cause the computing device 310 to generate an image to submit to the at least one LLM 302 by 1) capturing multiple views of the UI (via for example scrolling) and 2) concatenating the multiple views of the UI while eliminating duplicate areas so that the generated image is one “clean” image with no duplicate parts. Generating the concatenated image may further involve modifying the concatenated image so that stationary objects (such as a chat box icon) appear once and in the appropriate place (such as the bottom right corner).

Rendering and capturing the at least one image of the UI may involve auto-navigation that crawls some options of the UI. Crawling the UI may trigger banners or other semantically sensitive items to appear on the UI. The plug-in 314 may cause the computing device 310 to capture images of the UI displaying these semantically sensitive items for the purposes of compliance evaluation by the at least one LLM 302.

The plug-in 314 may add, to the IDE 312, selectable buttons or options in the IDE 312 with respect to use of the at least one LLM 302. For example, the IDE 312 may display a “check” button that, when selected, causes the at least one LLM 302 to identify or check a UI being developed in the IDE 312 for non-compliant sections. Additionally, or alternatively, the selectable buttons or options may allow the IDE 312 to check a UI for specific types of non-compliance. For example, the selectable buttons or options may include, without limitation, a first option for identifying non-compliance with respect to banners in the UI, a second option for identifying non-compliance with respect to a navigation bar in the UI, a third option for identifying non-compliance with respect to a menu in the UI, a fourth option for identifying non-compliance with respect to icon usage in the UI, and a fifth option for identifying non-compliance with respect to pop-ups in the UI.

In some embodiments, the plug-in 314 may add, to the IDE 312, a feature wherein the IDE 312 automatically causes, in response to a trigger event or trigger condition, the at least one LLM 302 to be prompted to identify non-compliance with respect to a UI. A trigger event or trigger condition may be, for example, committing code defining the UI to a repository or version control system, saving code defining the UI to either an internal or external storage medium, significant changes to the DOM (such as change involving a banner, a button, or a navigation item), styling updates and/or changes to CSS for the UI (especially changes involving color schemes, typography, or layout properties), changes in specific sections (such as banners and navigation bars), and significant visual changes to the UI that may be measured via image regression testing. In some embodiments, the plug-in 314 may cause the computing device 310 to periodically capture rendered images of the UI for the purpose of image regression testing. Additionally, or alternatively, the plug-in 314 may, for the purpose of image regression testing, automatically capture rendered images of the UI upon detecting that the computer code or computer script used to define the UI is being committed to a version control system and saved to a storage medium. The plug-in 314 may allow the computing device 310 to detect trigger events by monitoring the code or style sheets defining the UI via the IDE 312.

The plug-in 314 may further allow the IDE 312 to display a compliance evaluation window. The compliance evaluation window may, for example, after prompting the at least one LLM 302 to identify non-compliant sections in a UI, images of non-compliant sections based on bounding box data. Additionally, or alternatively, the compliance evaluation window may display, after prompting the at least one LLM 302 to identify non-compliant sections in a UI, an image of the rendered UI wherein the non-compliant sections are marked up (perhaps using overlay highlighting).

The plug-in 314 may further allow the computing device 310 to automatically capture images of the UI when the IDE 312 is in a “presentation mode” or a “demo mode” wherein the IDE 312 displays what the UI would look like if deployed. The computing device 310 or the computer system 300 may later use these captured images for a compliance evaluation via the at least one LLM 302.

While FIG. 3 depicts the IDE 312 as an IDE installed on the computing device 310, in some embodiments, the IDE 312 may be a web or online IDE. In such embodiments, the IDE 312 may be hosted on the computer system 300 or a server associated with the computer system 300. In such embodiments, the computing device 310 may access or use the IDE 312 by connecting to the computer system 300 or the associated server via a network such as the network 330. Further, in such embodiments, the IDE 312 may automatically provide the functionality offered by the plug-in 314.

FIG. 3 further depicts a database 320. The database 320 may store guidelines for a UI to adhere to. The computer system 300 or the computing device 310 may retrieve at least one of the guidelines stored in the database 320 and pass or provide the at least one of the guidelines to the at least one LLM 302 to perform a compliance check for a UI. Further, the computer system 300 may update the guidelines for a UI to adhere to. In such situations, the computer system 300 may fine-tune or retrain the at least one LLM 302 to accommodate evaluation of compliance against the new guidelines. The computer system 300 may then store the new guidelines in the database 320. The computer system 300 may also store, in the database 320, the older versions of the at least one LLM 302 in association with the old set of guidelines. The computer system 300 may retrieve and use the older versions of the at least one LLM 302 in the event that the guidelines are reverted to the old set of guidelines. Further, in some embodiments, the database 320 may store training data for training or fine-tuning the at least one LLM 302.

Additionally, or alternatively, the database 320 may store timestamped versions of a UI being developed via the IDE 312. The computing device 310 or the computer system 300 may detect, via the plug-in 314, significant changes to the UI by comparing the current version of the UI to a timestamped version stored in the database 320. The detection of the significant change may, in turn, cause the at least one LLM 302 to perform a compliance evaluation on the UI.

FIG. 3 further shows a network 330 connecting the computer system 300, the computing device 310, and the database 320. The network 330 may be, without limitation, a wireless network, a radio network, a cellular network, an intranet, an Internet network, a 5G network, a Wi-Fi network, a local area network, a wide area network, or a combination thereof. The computer system 300, the computing device 310, and the database 320 may send data and/or requests to and from each other via the network 330.

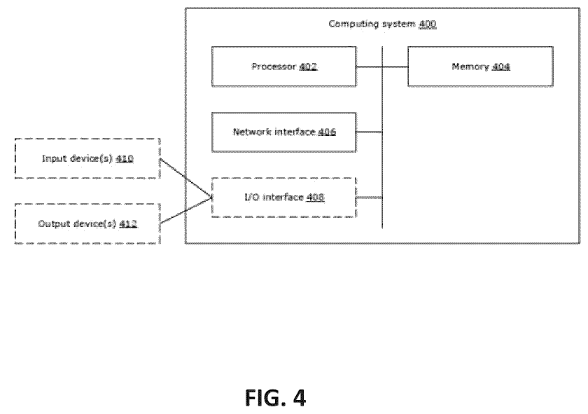

FIG. 4 illustrates an example computing system 400, which may be used to implement examples of the present disclosure, such as assisting app and web developers follow a set of guidelines with respect to a UI via an LLM. Additionally, or alternatively, one or more instances of the example computing system 400 may be employed to execute the LLM. For example, a plurality of instances of the example computing system 400 may cooperate to provide output using an LLM in manners as discussed above. In some embodiments, the computing system 400 may be exemplary of the computer system 300 (see FIG. 3). In some embodiments, the computing system 400 may be exemplary of the computing device 310 (see FIG. 3).

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

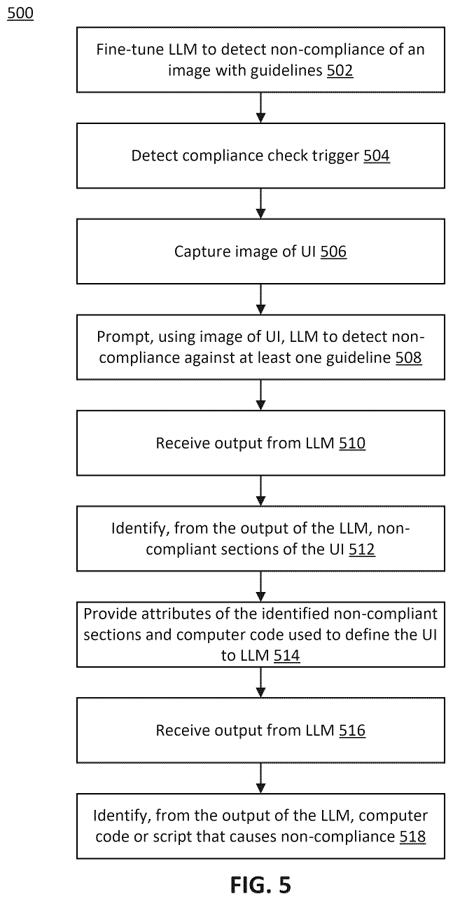

Reference is now made to FIG. 5 which shows, in flowchart form, a method 500 for using at least one multimodal LLM to perform a compliance evaluation on a UI. The method 500 may be implemented by a system suitably programmed to carry out the functions described such as the computer system 300, the computing device 310, or the computing system 400 (see FIGS. 3 and 4). In some embodiments, the operations of the method 500 may be implemented by a system comprising multiple computing devices or computing systems. For example, some operations of the method 500 may be performed via the collaboration of a first computer system and a second computer system. The system may comprise at least one processor and at least one memory coupled to the at least one processor. The at least one memory may be a non-transitory computer-readable medium storing instructions, that when executed by the at least one processor, cause the at least one processor to perform the operations of the method 500.

The method 500 may begin with an operation 502. At the operation 502, the at least one processor may train or fine-tune at least one LLM to detect non-compliance of a UI, or at least a portion of a UI, against a guideline or at least one guideline. Training data used to train or fine-tune the at least one LLM may include, without limitation, paired data wherein at least one of the pairs comprises an image showing at least a portion of a UI and a markup version of the image denoting or identifying sections of the UI that do not comply with at least one guideline. In another example, the training data used to train or fine-tune the at least one LLM may include paired data wherein at least one of the pairs comprises an image showing at least a portion of a UI and example corresponding output given the UI such as a JSON blob denoting or identifying sections of the UI that do not comply with the at least one guideline. Additionally or alternatively, the paired data may include a pair comprising an image showing at least a portion of the UI and example corresponding output indicating that the portion of the UI complies with at least one guideline. Additionally or alternatively, the example corresponding output may denote both compliant sections and non-compliant sections via, for example, JSON blobs or markup over the image. Further, in another example, the training data may include images showing at least a portion of the UI that are labelled “compliant” or “non-compliant.”

In addition to supervised learning using paired or labelled data, the at least one processor may use unsupervised learning to, at least partially, train the at least one LLM. For example, unsupervised learning may be used to train the at least one LLM by providing compliant or non-compliant data or image data of a UI to the at least one LLM. In some embodiments, one of the at least one LLM(s) may be fine-tuned using image data that is compliant or non-compliant for a particular guideline. For example, the one of the at least one LLM(s) may be trained specifically to identify compliance and non-compliance with respect to banners. Training this LLM may involve unsupervised learning that includes providing image data of UIs with compliant banners to the LLM. In this example, the “compliant” image data of the UI used to train the LLM may include non-compliant sections for areas unrelated to banners (such as a navigation bar). Similar techniques may be used to train the LLM using non-compliant image data. In addition to supervised or unsupervised learning, the at least one processor may train the at least one LLM or one of the at least one LLM(s) using, without limitation, semi-supervised learning, self-supervised learning, reinforcement learning, reinforcement learning with human feedback, transfer learning, few-shot learning, one-shot learning, zero-shot learning, or federated learning.

Following the operation 502, flow control may proceed to an operation 504. At the operation 504, the at least one processor may detect a compliance check trigger or a trigger condition. For example, the at least one processor may monitor changes made to a UI. Specifically, the at least one processor may monitor or track, via an IDE, changes or significant changes made to data defining the UI such as computer code of computer script. That is, the at least one processor may determine based on the monitored or tracked changes that the data defining the UI has been changed by a degree beyond a threshold. For example, the at least one processor may detect that changed or substantially changed computer code or computer script has been committed to a repository or version control system, or alternatively, saved to or otherwise stored in a storage medium or a permanent storage medium. Additionally, or alternatively, the at least one processor may detect a substantial change to a styling sheet used to define the UI. Additionally, or alternatively, the at least one processor may detect a significant change to the DOM of the UI (in the case that the UI is for a webpage). Additionally, or alternatively, the at least one processor may detect an edit to a semantically sensitive area of the UI such as a banner or navigation bar. That is, the at least one processor may detect that at least a first element of the UI with a known compliance guideline has been changed. Additionally, or alternatively, the at least one processor may capture rendered images of the UI (e.g. in response to a trigger event or periodically) and perform an image regression analysis to detect significant or substantial visual changes. That is, the at least one processor may determine, based on the image regression analysis, that the UI has, compared to an earlier version, visually changed by a degree beyond a threshold. In various embodiments, detection of any of the above-described changes may qualify as a trigger event, trigger condition, or compliance check trigger. Additionally, or alternatively, detecting selection of an option in an IDE to perform a compliance evaluation may qualify as a trigger event, trigger condition, or compliance check trigger.

Following the operation 504, flow control may proceed to an operation 506. At the operation 506, the at least one processor may capture an image or at least one image showing at least a portion of the UI. In some embodiments, the at least one processor may render or generate an image of the UI before capturing it.

Following the operation 506, flow control may proceed to an operation 508. At the operation 508, the at least one processor may prompt, the at least one LLM to identify an element or at least one element of the UI that is non-compliant with a guideline or at least one guideline. The guideline or at least one guideline may include a semantic criterion pairing a textual context with a visual condition. The prompting may further include passing or providing an image showing at least a portion of the UI to the at least one LLM. The passed or provided image may be an image captured during the operation 506. The prompting may further include passing or providing data representative of the guideline or at least one guideline to the at least one LLM.

In some embodiments, prior to the prompting, the operation 508 may further comprise selecting the at least one LLM. For example, the at least one LLM may be a first LLM of a plurality LLMs. The plurality of LLMs may include LLMs that have been trained or fine-tuned to identify or detect non-compliance with respect to a particular guideline or a particular set of guidelines. For example, the plurality of LLMs may include a first LLM fine-tuned to evaluate banners, a second LLM fine-tuned to evaluate navigation bars, and a third LLM fine-tuned to evaluate icon usage. Hence, the operation 508 may involve determining that a first LLM, for example for evaluating banners, evaluates compliance of the UI with the guideline and selecting the first LLM, from the plurality of LLMs, for prompting. In some embodiments, the at least one processor may select the first LLM based on user selection. For example, a user or developer of an IDE for developing a UI may select that the UI be evaluated for compliance with a particular guideline. Such a selection may map to the first LLM being selected to evaluate compliance. In another example, the first LLM may be selected based on tracked changes to the UI. For example, an IDE may detect significant or substantial changes to a banner in a UI. Such a detection may lead to a banner-evaluating LLM to be selected for the prompting in the operation 508.

In some embodiments, the at least one processor may perform or execute the operations 506 and 508 in response to the operation 504. That is, the at least one processor may capture the at least one image of the UI and/or prompt the at least one LLM in response to detecting the trigger condition, trigger event, or compliance check trigger.

While FIG. 5, depicts the operations 504, 506, and 508 in sequence, in some embodiments, similar operations may be performed in a different sequence. For example, the at least one processor may have captured a representative image of the UI prior to detecting the trigger condition, trigger event, or compliance check trigger. In this example, the at least one processor may perform an operation similar to the operation 508 in response to detecting the trigger condition or trigger event. That is, the at least one processor may skip the operation of capturing the at least one image of the UI after detecting the trigger condition or trigger event because a representative image of the UI has already been captured.

Following the operation 508, flow control may proceed to an operation 510. At the operation 510, the at least one processor may receive output, or a first output, of the at least one LLM. The output of the at least one LLM may include structured output generated by the at least one LLM, such as a JSON blob, wherein the structured output denotes at least one UI element that does not comply with the at least one guideline. Additionally, or alternatively, the output of the at least one LLM may include or cause the generation of a markup image of the UI denoting or identifying at least one UI element that does not comply with the at least one guideline (perhaps using overlay highlighting). Additionally, or alternatively, the at least one LLM may output bounding box data that the processor may use to extract at least one image depicting the non-compliant UI element or at least one non-compliant UI element.

Following the operation 510, flow control may proceed to an operation 512. At the operation 512, the at least one processor may identify, based on the first output, an element or at least one element of the UI that is non-compliant with the guideline or at least one guideline. The at least one processor may further present, on a display, an indication that the element or at least one element is non-compliant. For example, in the event that the at least one LLM generates structured output denoting non-compliant sections or elements of a UI, the at least one processor may render or generate, subsequent to identifying the element or at least one element, and based on the structured output, a markup image of the UI wherein the markup image visually identifies or denotes the non-compliant sections or UI elements. For example, the at least one processor may overlay highlights on the markup image of the UI wherein the highlights indicate the non-compliant element or at least one element. Additionally, or alternatively, the at least one processor may extract, based on bounding box data received in the first output, a markup image depicting the non-compliant element or at least one element of the UI. The at least one processor may further present the extracted markup image on a display, via, for example, an IDE.

Further, at the operation 512, the at least one processor may present, on the display, a selectable element prompting a developer to indicate whether the output of the at least one LLM or identified non-compliant sections are accurate or helpful. For example, the selectable element may be a confirmation box with the message “Are the identified non-compliant sections correct?” and yes/no buttons. In the event that the “yes” button is selected, the at least one processor may store, as paired data and in a database, the image showing the portion of the UI and the corresponding output of the at least one LLM. At a later time, the at least one processor may retrieve the pair from the database to further train or fine-tune the LLM in a process similar to the operation 502.

Following the operation 512, flow control may proceed to an operation 514. At the operation 514, the at least one processor may pass or provide, to the at least one LLM, data defining the UI. The data defining the UI may be understood to be computer code or script used to define the UI such as code or script written in HTML, Javascript, Python, or CSS. At the operation 514, the at least one processor may further prompt the at least one LLM to identify a data segment of the data defining the UI causing non-compliance of the element or UI element with the guideline or at least one guideline. The prompting may include passing or providing, to the at least one LLM, at least one attribute associated with the element or at least one. The data segment may be understood to be a segment of the computer code or computer script. In some embodiments, the at least one processor may perform or execute the operation 514 in response to the operation 512. That is, the at least one processor may prompt the at least one LLM to identify the data segment in response to identifying the at least one non-compliant UI element.

In some embodiments, the operations 508 and 514 may involve prompting different LLMs. For example, the at least one LLM may comprise a plurality of LLMs and the operation 508 may involve prompting a first one of the plurality of LLMs and the operation 514 may involve prompting a second one of the plurality of LLMs, the first one and the second one of the LLMs being different LLMs.

Following the operation 514, flow control may proceed to an operation 516. At the operation 516, the at least one processor may receive output, or a second output, of the at least one LLM. The second output may include, for example, snippets of computer code or computer script that can be found in the data defining the UI. Additionally, or alternatively, the second output may include data that indexes or identifies segments of computer code or computer script (e.g. “line xxxx of example_file.html”).

Following the operation 516, flow control may proceed to an operation 518. At the operation 518, the at least one processor may identify, based on the second output, the data segment that causes non-compliance of the UI or UI element. For example, in the case of HTML for a webpage, the at least one processor may identify a node in the DOM that causes non-compliance of the UI. Further, the at least one processor may present, on a display, an indication based on the data segment or, alternatively, an indication that the identified data segment causes non-compliance of the UI with the guideline or at least one guideline. For example, the at least one processor may cause, in an IDE, overlay highlighting to appear over the non-compliance causing data segment.

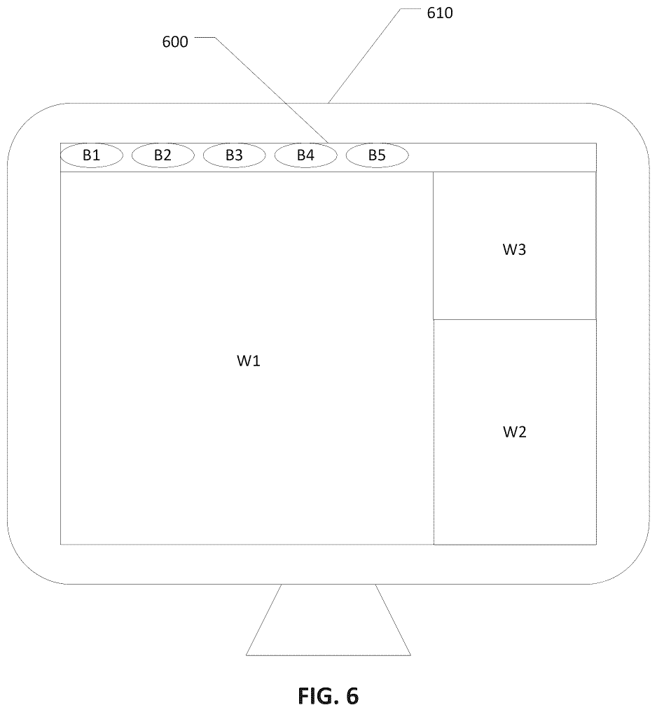

Reference is now made to FIG. 6 which is a simplified diagram of a non-limiting example of a user interface 600 of an IDE used for detecting non-compliance of a UI with a set of guidelines. In some embodiments, the IDE shown in FIG. 6 may be exemplary of the IDE 312 (see FIG. 3). In FIG. 6, a monitor 610 displays the user interface 600. The monitor 610 may be a part of, for example, the computing device 310 (see FIG. 3).

FIG. 6 shows the user interface 600 having display windows W1, W2, and W3. The display window W1 may display or present rendered images of a UI being developed using the IDE. The IDE may periodically, or in response to trigger conditions or trigger events, capture images of the UI presented in the display window W1. Further, in some embodiments, in response to prompting at least one LLM to identify UI elements that to not comply with a set of guidelines, W1 may display a markup image of the UI wherein the markup identifies non-compliant UI elements (perhaps via overlay highlighting).

The display window W2 may be a window that a developer uses to write computer code or computer script (e.g. HTML and Javascript) that at least partially defines the UI. That is, the display window W2 may display data defining the UI. Further, in response to prompting at least one LLM to identify or detect computer code or computer script segments or lines that cause non-compliance of a UI with a set of guidelines, W2 may display indications, such as overlay highlighting, that identify such computer code or computer script segments.

The display window W3 may display, in response to prompting at least one LLM to identify UI elements that do not comply with a set of guidelines, images that identify the non-compliant UI elements. For example, W3 may display images of non-compliant UI elements extracted based on bounding box data in output of the LLM. In some implementations, the display window W3 may be considered a compliance evaluation window.

In some embodiments, the display windows W1, W2, and W3 may not be fixed. For example, a developer or user of the IDE may selectively open or close any of the display windows W1, W2, and W3. Additionally, or alternatively, the IDE may automatically open any of the display windows W1, W2, and W3. In an example scenario, a developer or user may only have the display windows W1 and W2 opened in the IDE. In response to prompting at least one LLM to identify non-compliant sections of a UI, the IDE may open the display window W3 to show extracted images based on bounding box data in output of the at least one LLM.

While FIG. 6 shows three display windows, namely the display windows W1, W2, and W3, other embodiments of the IDE may provide for more or less display windows.

FIG. 6 further shows the user interface 600 having buttons B1, B2, B3, B4, and B5. These buttons may allow a user or developer of the IDE to use features provided by the IDE. For example, selecting one of the buttons, say B5, may cause a dropdown menu to appear wherein the dropdown menu allows the user or developer to prompt at least one LLM to perform a compliance evaluation. In some embodiments, the user or developer may be able to prompt a particular LLM out of a plurality of LLMs to perform a compliance check. For example, the user or developer may have finished writing computer code or computer script for a navigation bar of UI. The user or developer may then click on the button B5 which leads to a dropdown menu being displayed. The dropdown menu may present operations for, without limitation, a compliance check for banners, a compliance check for navigation bars, and a compliance check for icon usage. The user or developer, in this example scenario, may select the option for a compliance check for navigation bars.

While FIG. 6 shows 5 buttons, namely the buttons B1, B2, B3, B4, and B5, other embodiments of the IDE may provide for more or less buttons.

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g. Long Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method, the computer-implemented method comprising:
detecting a trigger condition;
prompting a large language model to identify an element of a user interface non-compliant with a guideline, wherein prompting includes providing an image showing at least a portion of the user interface to the large language model;
receiving a first output of the large language model;
identifying, based on the first output, the element that is non-compliant with the guideline; and
presenting, on a display, an indication that the element is non-compliant.

2. The computer-implemented method of claim 1 wherein the guideline includes a semantic criterion pairing a textual context with a visual condition.

3. The computer-implemented method of claim 1 wherein the method further comprises:
in response to identifying the element,
providing, to the large language model, data defining the user interface; and
prompting the large language model to identify a data segment of the data, the data segment causing non-compliance of the user interface with the guideline;
receiving a second output of the large language model;
identifying, based on the second output, the data segment; and
presenting, on the display, an indication based on the data segment.

4. The computer-implemented method of claim 1 wherein the method further comprises fine-tuning the large language model to detect non-compliance of the user interface with the guideline.

5. The computer-implemented method of claim 1 wherein detecting the trigger condition further comprises:
performing an image regression analysis; and
determining, based on the image regression analysis, that the user interface has visually changed by a degree beyond a threshold.

6. The computer-implemented method of claim 1 wherein detecting the trigger condition further comprises detecting that a change to data defining the user interface has been stored in a permanent storage medium.

7. The computer-implemented method of claim 1 wherein detecting the trigger condition further comprises:
tracking changes to data defining the user interface; and
determining based on the tracked changes that the data defining the user interface has been changed by a degree beyond a threshold.

8. The computer-implemented method of claim 1 wherein detecting the trigger condition further comprises detecting that at least a first element of the user interface with a known compliance guideline has been changed.

9. The computer-implemented method of claim 1 wherein presenting the indication on the display further comprises:
rendering, subsequent to identifying the element, a markup image of the user interface; and
overlaying highlights on the markup image of the user interface, the highlights indicating the element.

10. The computer-implemented method of claim 1 wherein presenting the indication on the display further comprises:
extracting, subsequent to identifying the element, based on bounding box data, a markup image depicting the element; and
presenting the markup image on the display.

11. The computer-implemented method of claim 1 wherein the method further comprises, prior to prompting the large language model to identify at least one element of the user interface non-compliant with the guideline, capturing the image showing at least the portion of the user interface.

12. The computer-implemented method of claim 1 wherein the large language model is a first large language model of a plurality of large language models and the method further comprises, prior to prompting the large language model to identify the element:
determining that the first large language model evaluates compliance of the user interface with the guideline; and
selecting the first large language model from the plurality of large language models.

13. A computer system, the computer system comprising:
at least one processor;
at least one memory coupled to the at least one processor, the at least one memory storing instructions that, when executed by the processor, cause the processor to:
detect a trigger condition;
prompt a large language model to identify an element of a user interface non-compliant with a guideline, wherein prompting includes providing an image showing at least a portion of the user interface to the large language model;
receive a first output of the large language model;
identify, based on the first output, the element that is non-compliant with the guideline; and
present, on a display, an indication that the element is non-compliant.

14. The computer system of claim 13 wherein the guideline includes a semantic criterion pairing a textual context with a visual condition.

15. The computer system of claim 13 wherein the instructions further configure the at least one processor to:
in response to identifying the element,
provide, to the large language model, data defining the user interface; and
prompt the large language model to identify a data segment of the data, the data segment causing non-compliance of the user interface with the guideline;
receive a second output of the large language model;
identify, based on the second output, the data segment; and
present, on the display, an indication based on the data segment.

16. The computer system of claim 13 wherein the instructions further configure the at least one processor to fine-tune the large language model to detect non-compliance of the user interface with the guideline.

17. The computer system of claim 13 wherein presenting the indication on the display further comprises:
rendering, subsequent to identifying the element, a markup image of the user interface; and
overlaying highlights on the markup image of the user interface, the highlights indicating the element.

18. The computer system of claim 13 wherein presenting the indication on the display further comprises:
extracting, subsequent to identifying the element, based on bounding box data, a markup image depicting the element; and
presenting the markup image on the display.

19. The computer system of claim 13 wherein the large language model is a first large language model of a plurality of large language models and the instructions further configure the at least one processor to, prior to prompting the large language model to identify the element:
determine that the first large language model evaluates compliance of the user interface with the guideline; and
select the first large language model from the plurality of large language models.

20. A non-transitory computer-readable medium storing instructions that, when executed by at least one processor, causes the at least one processor to:
detect a trigger condition;
prompt a large language model to identify an element of a user interface non-compliant with a guideline, wherein prompting includes providing an image showing at least a portion of the user interface to the large language model;
receive a first output of the large language model;
identify, based on the first output, the element that is non-compliant with the guideline; and
present, on a display, an indication that the element is non-compliant.
